(19) United States
(12) Patent Application Publication
(10) Pub. No.: US 2024/0198577 A1
(43) Pub. Date: Jun. 20, 2024

(54) FEED DEVICE

(71) Applicant: M. TANNER AG, Winterthur (CH)

(72) Inventor: Marcel TANNER, Bassersdorf (CH)

(21) Appl. No.: 18/287,253

(22) PCT Filed: Apr. 21, 2022
(86) PCT No.: PCT/EP2022/060624

§ 371 Date: Oct. 17, 2023

(30) Foreign Application Priority Data
Apr. 23, 2021 (CH) 00440/21

(51) Int. Cl. B29C 49/42

(52) U.S. Cl. CPC B29C 49/42065; B29C 49/42097; B29C 49/42101; B29C 2949/0715

(57) ABSTRACT

A feed device (1) for a conveyor system (10) for preforms (4) is described, which is designed to convey preforms (4) coming in an orderly manner from an upstream module (109) of the conveyor system (10) to a downstream module (1011) of the conveyor system (10), the feed device (1) comprising a first and a second conveyor belt (11; 12), wherein a conveying path for the preforms (4) is formed between a first belt section of the first conveyor belt (11) and a second belt section of the second conveyor belt (12), wherein the first and second conveyor belts (11; 12) are arranged in such a way that a lateral edge surface (110) of the first conveyor belt (11) and a lateral edge surface (120) of the second conveyor belt (12) form a support for a supporting ring (41) of a preform (4), wherein the support can be brought into engagement with the underside of the supporting ring (41) in such a way that an accumulation force is applied in the conveying direction (F) to the preform (4) located in the conveying path.

### FIELD OF THE INVENTION

The present invention relates to a feed device for a conveyor system for preforms.

### INVENTION BACKGROUND

A feed device for feeding preforms made of thermoplastic material with a support ring in the region of the open end to a blow molder for producing, in particular, PET plastic bottles is described, for example, in DE 203 08 513 U1. The apparatus has a silo set up close to the floor for the random storage of a large number of preforms, which is periodically filled from above by pouring in the preforms delivered in boxes. A roller sorter with two counter-rotating cylindrical rollers is installed near the bottom of the silo and inclined slightly downward in the direction of transport. An inclined conveyor removes the preforms in a disorderly manner from the bottom of the silo and fills them at the upper end of the roller sorter. The upper end of the roller sorter is approx. 1 meter above the floor, the lower end correspondingly lower. Immediately upstream of the infeed star of the linear oven is an inclined chute comprising two spaced support rails. The preforms rest with their support rings on the support rails and, driven by the slope drive, can slide between them in the direction of the infeed star. The chute has a certain buffer function to ensure uninterrupted feeding of the stretch blow molder and can therefore accommodate well over 100 preforms. Accordingly, its upper end is more than 3 meters above the floor. To overcome the difference in height of around 2 meters or more between the outlet of the roller sorter, which sorts the preforms fed in disorder at the upper end into a single row between its two rollers in a conventional manner and aligns them with the open end facing upwards, and the upper feed end of the chute, an elevator is interposed.

Another feed device for preforms is described, for example, in EP 3 453 648 A1. The feed device has two transport rails arranged opposite each other, on which the preforms rest with their support ring during transport. Furthermore, the feed device shown therein has six belt transport units arranged in pairs opposite each other, which are arranged above the transport rails in such a way that the belts of the belt transport units engage with the threaded section of the preforms and clamp them between the belts with a pressing force. The required pressing force is preferably achieved by spring pretensioning of several belt transport rollers over which the belts of the belt transport units run. The drives of the belt transport units, which are preferably designed as servomotors, apply a torque to the preforms accumulated in the feed device which is maintained without the belts slipping.

### SUMMARY OF THE INVENTION

In the case of feed devices for preforms, it is typically desirable to simplify the design, with, for example, a reduction in the number of components and a design close to the floor with a low inclination of the conveyor section being preferred. At the same time, it is desirable to ensure adequate hygiene, since the containers blown from the preforms are typically filled with beverages intended for consumption.

It is therefore an object of the present invention to provide a feed device for a conveyor system for preforms as well as a conveyor system with such a feed device, which at least partially improves the prior art.

This object is achieved with a feed device having the features of independent claim 1. Advantageous embodiments of the invention are given in the dependent claims and in the present description as well as in the figures.

The invention relates to a feed device for a conveyor system for preforms, which is designed to convey preforms coming in an orderly manner from an upstream module of the conveyor system to a downstream module of the conveyor system, the feed device comprising a first and a second conveyor belt guided over at least two rollers in each case, a conveying path for the preforms being formed between a first belt section of the first conveyor belt and a second belt section of the second conveyor belt, wherein the first and the second conveyor belts are arranged in such a way that a lateral edge surface of the first conveyor belt and a lateral edge surface of the second conveyor belt form a support for a support ring of a preform, wherein the support can be brought into engagement with the underside of the support ring in such a way that an accumulation force is applied in the conveying direction to the preform located in the conveyor path.

The preforms are preferably molded from polyethylene terephthalate and typically have an outer threaded section in the region of their opening, which is joined by an outwardly projecting support ring, with an elongated, substantially cylindrical section with a rounded, closed end typically joining below the support ring. The elongated section may, in certain preforms, include a tapered section which connects below the support ring. In addition, in the context of the present invention, orderly conveyed preforms are understood to be upright, with the opening oriented upward, and conveyed in a row.

The feed device offers the advantage that the conveyor belts can provide both a support for the support ring of the preform for conveying the preforms in the conveying direction along the conveying path and an application of an accumulation force or accumulation pressure to preforms accumulated in the conveying path. In particular, a transport rail for the carrier rings or preforms can be dispensed with, which simplifies the design of the feed device. Moreover, since the conveying of the preforms is not based on sliding on transport rails, there is no need to provide the conveying section with a considerable gradient in the conveying direction. Furthermore, the feed device improves hygiene, since the threaded section of the preform conveyed in the feed device remains free during conveying, i.e. is not contacted. In addition, compared to devices in which the preform is clamped at the threaded section, it is not necessary to generate a pressing force for the clamping.

Advantageously, the conveyor path defined by the feed device provides a buffer path in which the preforms can be accumulated and which can be filled with them. By accumulating preforms in the feed device, the preforms can be transferred efficiently and reliably to a downstream take-off device, in particular a separating device.

In an embodiment of the feed device, a surface of each of the first and second conveyor belts oriented perpendicular to the edge surface forms two opposing stabilizing surfaces for the section of the preform adjoining below the support ring, which can be brought into engagement with the section of the preform adjoining below the support ring in such a way that a deflection of the preform located in the conveyor path transverse to the conveying direction is limited and optionally the conveying of the preform is supported.

The stabilizing surfaces of the conveyor belts can be used to limit the deflection of the preforms transverse to the conveying direction. This is particularly advantageous for the accumulation of preforms, since preforms tend to be deflected transversely to the conveying direction during accumulation. By limiting the transverse deflection of the preforms, it is therefore possible to stabilize the preforms and improve the orderly conveying of the preforms in the feed device. For the stabilization of the preforms, it is thereby advantageously sufficient if the stabilizing surfaces contact the elongated section below the support ring when the transverse deflection is too great. Clamping engagement is therefore typically not required for stabilization purposes.

Furthermore, the transport of the preforms can be supported by contact with the surfaces of the conveyor belts, which form the stabilizing surfaces. In certain embodiments, the stabilizing surfaces can act as driving surfaces and, in addition to the edge surfaces forming a support, generate an accumulation force or accumulation pressure on the preforms.

The conveyor belts of the feed device can therefore advantageously achieve at least a quadruple function, which comprises the provision of a support for the supporting ring, the conveying of the preforms in the conveying path defined by the conveyor belts or the first and second belt sections, the generation of an accumulation force or accumulation pressure on the preforms, and the stabilization of the preforms in the conveying path.

In an embodiment, the feed device has a drive for each conveyor belt.

Alternatively, the feed device has a common drive for the first and second conveyor belts, which is preferably set up to generate a torque of between 10 Nm and 12 Nm.

With a common drive for both conveyor belts, the design of the feed device can be further simplified. By means of a reversing gear, the opposite directions of rotation of the first and second conveyor belts can be generated with the common drive. Preferably, a gearbox with a 10:1 reduction ratio is further provided, which generates a torque of between 10 Nm and 12 Nm at the output, whereby a torque of between 5 Nm and 6 Nm can thereby be provided for each conveyor belt. For the drive, a motor with a speed of 1000 rpm can be used, for example, so that a speed of 100 rpm can be generated for the conveyor belts.

In an embodiment, the conveyor belts are made of a plastic material.

The conveyor belts can be made of a polyurethane or a polyester or a polyamide, for example.

The plastic material advantageously provides a suitable frictional force between the conveyor belt and the preform, in particular between the support and the support ring, so that conveying of the preform and generation of accumulation force or accumulation pressure is made possible, while at the same time providing a suitable sliding slip, as described further below.

In an embodiment, the conveyor belts are in the form of toothed belts, the support for a support ring of a preform being formed at least in part by side edges of the teeth of the toothed belts.

Since the teeth of the toothed belts extend perpendicularly to the surface of the conveyor belts serving as a stabilizing surface, the teeth can serve as a support for the support ring of a preform in addition to the engagement function in a drive gear through the side edges.

In an embodiment, the edge surfaces of the conveyor belts, which are designed as a support for a support ring of a preform, are designed in such a way that when a limit accumulation force is exceeded on a preform located in the conveyor path, a sliding slip occurs between the edge surfaces and the support ring of the preform.

The sliding slip enables the conveyor belts of the feed device to slip under the support rings of the preforms when they are jammed, allowing further preforms to follow and to be closed and jammed in addition to the already jammed preforms. The conveyor belts of the feed device can therefore continue to run without interruption when preforms are jammed and continuously fill up the conveyor section in the feed device. Since the sliding slip only occurs when a limit accumulation force is exceeded, however, it can be ensured at the same time that a continuous accumulation force or accumulation pressure is exerted on the accumulated preforms. By providing a sliding slip, it can also be ensured that the accumulation force or accumulation pressure does not become too high.

In order to provide the sliding slip, it is advantageous to manufacture the conveyor belts from a suitable plastic. It is further advantageous for the provision of sliding slip that the conveyor belts do not have to clamp the preform as already described.

Accordingly, in certain embodiments, the sliding slip may also occur between the surfaces designed as stabilizing surfaces and the section of the preform adjoining under the support ring.

Preferably, the stabilizing surfaces of the conveyor belts are aligned vertically.

Alternatively, the stabilizing surfaces of the conveyor belts can have an inclination of between 5° and 10° with respect to the vertical.

In an embodiment, the conveyor belts each have a stabilizing surface, which are designed in such a way that the distance between the conveyor belts in the conveyor path increases preferably in the direction away from the support.

By increasing the distance between the stabilizing surfaces, stabilization can advantageously be achieved for preforms in which the elongated section located below the support ring has a profile deviating from a straight cylinder. For example, advantageous stabilization can be achieved for a preform with an outwardly curved section or a conically widening section.

In an embodiment, the stabilizing surfaces each have a step that divides the stabilizing surfaces into a first partial stabilizing surface and a second partial stabilizing surface.

The steps of the stabilizing surfaces of the conveyor belts can each be designed as an undercut. Due to the gradation of the stabilizing surfaces, the distance between the conveyor belts increases preferably in a step-like manner. In particular, each stabilizing surface can have a first and a second partial stabilizing surface as a result of the gradation, which can be oriented vertically, the first partial stabilizing surface preferably adjoining the lateral edge surface forming the support and the second partial stabilizing surface being arranged below the first partial stabilizing surface. The first partial stabilization surfaces of the first and second conveyor belts may define a first spacing between the conveyor belts and the second partial stabilization surfaces of the first and second conveyor belts may define a second spacing between the conveyor belts, the second spacing preferably being greater than the first spacing. The spacing may include a sloping or horizontal sub-surface connecting the first and second partial stabilization surfaces.

In an embodiment, the conveyor belts are arranged such that the conveyor path is horizontal.

Alternatively, the conveyor belts can be arranged in such a way that the conveyor path is inclined in the conveying direction. The conveyor path can, for example, have a gradient of between 1° and 20°, preferably between 5° and 10°, relative to the horizontal.

In an embodiment, the conveyor belts have a width such that the stabilizing surfaces cover at least one-twentieth, preferably at least one-tenth, more preferably at least one-fifth, further more preferably at least one-quarter, of the height of the preform located in the conveyor path.

By selecting a suitable width of the conveyor belts, the stabilizing function can be tuned in the desired way.

In an embodiment, the conveyor belts have a width of between 10 and 50 mm.

In an embodiment, a minimum sensor for detecting preforms is arranged on the downstream section of the conveying path of the feed device and a maximum sensor for detecting preforms is arranged on the upstream section of the conveying path of the feed device.

The minimum sensor can detect the presence and absence of preforms and is preferably connected to a control system. If the minimum sensor no longer detects any preforms in its range, the level has fallen below the minimum level and an alarm signal can be triggered, for example, so that possible faults in upstream units can be eliminated. At the same time, the downstream module, such as a blow molder or an infeed star of a clamp conveyor or an inspection system, can be stopped, i.e. production can be interrupted.

If the maximum sensor does not detect any preforms in its range, the conveying of preforms in the upstream module, e.g. in a roller sorter, can be accelerated to refill the conveying path in the feed device.

After eliminating the source of the error that led to the level falling below the minimum level, production is preferably not restarted until the conveyor path in the feed device has been refilled with preforms so that the maximum sensor does not detect any gaps.

Preferably, the minimum sensor and the maximum sensor are designed as light barriers.

In an embodiment, at least one gap detection sensor, preferably at least two, particularly preferably four or more, gap detection sensors is/are arranged between the minimum sensor and the maximum sensor, which is/are set up to detect gaps in the conveying path between preforms.

With the detection of gaps by the gap detection sensors, a catch-up mechanism can be set in motion so that preforms are conveyed faster to close these gaps. Preferably, the gap detection sensors are set up to detect gaps between preforms that are comparable or larger than the diameter of a preform.

Preferably, the gap detection sensors are designed as light barriers.

For this purpose, the gap detection sensor or sensors is or are preferably connected to a control system which, upon detection of one or more gaps, controls the at least one drive in such a way that the circulation speed of the conveyor belts is increased.

By increasing the circulation speed of the conveyor belts, the gaps can be closed by subsequently conveying preforms. The sliding slip described above allows the conveyor belts to slip under the already jammed preforms and at the same time close the gaps by subsequently conveying preforms, so that it is effectively possible to make up for a gap in conveying. Alternatively or in addition, a line-up sorter connected upstream of the feed device can be controlled so that preforms are conveyed at a higher speed by the line-up sorter.

In an embodiment, at least one pair of oppositely arranged air nozzle units are provided below each conveyor belt, which support the transport of the preforms in the conveying direction at least temporarily.

The air nozzle units preferably have inclined or gill-shaped air nozzles which can act on the elongated section of the preforms below the support ring with one or more blasts of air. This can be used, for example, if one or more preforms get stuck or jammed in the conveyor path, creating a gap. The gap can in turn be detected by a gap detection sensor and the respective air nozzle units activated.

The air nozzle units may also, in certain embodiments, assist in the transfer of preforms from the feed device to a downstream take-off device of the conveyor system.

In an embodiment, the conveyor belts, the sensors and/or the air nozzle units are arranged so as to be adjustable in the direction transverse to the conveyor path by means of a width adjustment device. In this way, the feed device can be adjusted to preforms of different sizes or diameters.

In an embodiment, the width adjustment device has at least two oppositely arranged lateral fastening profiles, each of which is mounted on support rods that can be moved towards and away from each other. This can provide a particularly efficient and accurate width adjustment mechanism.

In an embodiment, the conveyor belts, the sensors and/or the air nozzle units are each fastened to the lateral fastening profiles. The lateral fastening profiles preferably have at least two lateral fastening rails and one upper and one lower fastening rail. They can therefore be fitted with additional components in a particularly variable manner.

In an embodiment, a height limit for the preforms is provided, which can be mounted in a height-adjustable manner, e.g. in a guide. Preferably, the height limit is a C-profile which is arranged above the opening of the preforms and holds down the preforms in the feed device (and preferably also during the transition into the feed device).

In an embodiment, the guide is mounted on an upper fastening profile of the feed device. The height limit is preferably vertically movable via a height adjustment element, whereby the height adjustment element is also mounted on the upper fastening profile. The upper fastening profile preferably corresponds to the lateral fastening profiles. Cable ducts can be mounted on its lateral fastening rails. The height adjustment element is preferably in the form of a lever arrangement which can be actuated from the outside via an operating element.

The invention further relates to a conveying system for preforms comprising a feed device according to the invention and a plurality of preforms which are conveyed at a variable distance from one another in the conveying path of the feed device, wherein an accumulation force or accumulation pressure can be applied to the preforms in a downstream section of the conveying path of the feed device.

In an embodiment of the conveying system, the feed device is arranged downstream of a line-up sorter, preferably a roller sorter or centrifugal sorter, and upstream of a take-off device, preferably an infeed star or infeed rollers.

In an embodiment of the conveying system, the conveyor system comprises a control system that is connected to the minimum sensor and/or the maximum sensor and/or the gap detection sensors of the feed device and, upon detection of one or more gaps, controls the at least one drive such that the circulation speed of the conveyor belts is increased.

### LIST OF FIGURES

Exemplary embodiments of the invention are explained in more detail with reference to the following figures and the accompanying description. It schematically shows:

FIG. 1 a perspective view of an embodiment of a feed device according to the invention;

FIG. 2 a frontal view of a section of the feed device from FIG. 1;

FIG. 3 a section of a perspective cut view of the feed device from FIG. 1;

FIG. 4 a top view of an embodiment of a conveying system;

FIG. 5 a cut view of a section of an embodiment of a feed device according to the invention.

### DESCRIPTION OF EXEMPLARY EMBODIMENTS

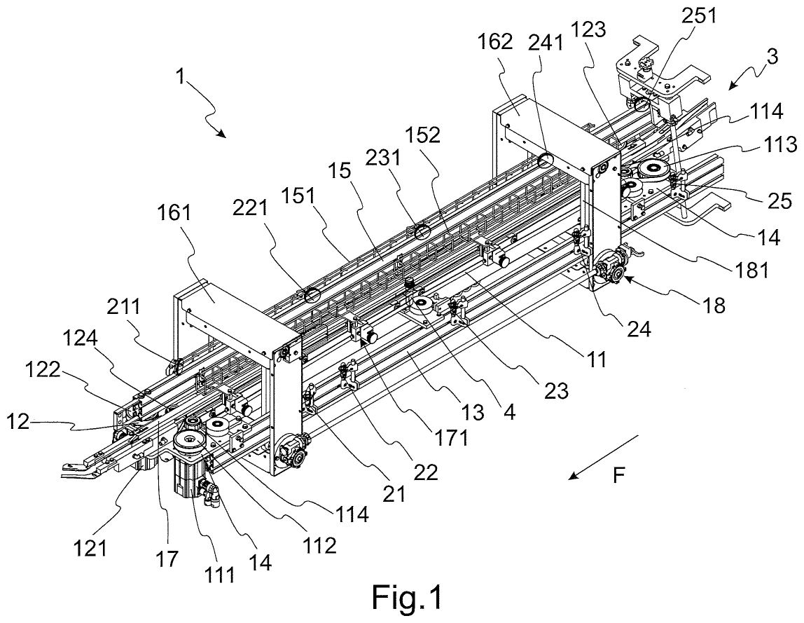

FIG. 1 shows a perspective view of an embodiment of a feed device 1 comprising two frames 161 and 162, each with a width adjustment device 18. The width adjustment device 18 comprises two support rods 181, which can be moved towards and away from each other via a spindle. A lateral fastening profile 13 is mounted on each of the support rods 181. A minimum sensor 21, two gap detection sensors 22, 23, 24 and a maximum sensor 25, which are designed as light barriers with corresponding reflectors 211, 221, 231, 241, 251, are mounted on the lateral fastening profiles 13.

Via a transfer section 3, preforms 4 arrive, e.g. from a roller sorter, in the feed device 1. The preforms 4 rest on lateral edge surfaces of a first conveyor belt 11 and a second conveyor belt 12 (partially hidden in FIG. 1) via the support ring and are conveyed in conveying direction F in a conveying path formed between a first belt section of the first conveyor belt 11 and a second belt section of the second conveyor belt 12.

Mounting plates 14 are mounted on the lateral fastening profiles 13, with a first drive 111 for the first conveyor belt 11 and a second drive 121 for the second conveyor belt 12 being arranged on a mounting plate 14, which drive rollers 112 and 122, respectively. The first conveyor belt 11 runs over rollers 112 and 113, and the second conveyor belt 12 runs over rollers 122 and 123. Further, outer guide rollers are provided for both conveyor belts 11 and 12.

The conveyor belts 11, 12 are designed as toothed belts and each run over two toothed wheels 114 and 124 (the second toothed wheel for the second conveyor belt 12 in the area of the roller 123 is concealed and not visible in FIG. 1). The side edges of the teeth of the toothed belts (not shown in FIG. 1), which are oriented upwards in FIG. 1, form the support for the support ring of the preform 4.

In the upper area of the feed device, an upper fastening profile 15 is arranged, which is fastened to the frames 161, 162. Cable ducts 151, 152 are fastened to the side of the upper fastening profile 15. Height adjustment elements 171 are further attached to the upper fastening profile 15, which hold a height limit 17 above the preform 4. The height limit 17 (as well as other elements of the feed device 1, such as parts of the conveyor belts) is shown partially transparent for better visibility of the preform 4.

In normal operation, the conveying path of the feed device 1 is preferably filled with preforms 4 over its entire length.

If one of the gap detection sensors 22, 23, 24 detects a gap in its detection range, the drives 111 and 121, for example, are controlled at a higher speed to feed preforms and close the gap. If the minimum sensor 21 no longer detects any preforms in its range, the level has fallen below the minimum level and an alarm signal can be triggered, for example, so that possible faults in upstream units can be eliminated. At the same time, a downstream device, such as a blow molder or an infeed star of a clamp conveyor or an inspection system, can be stopped, i.e. production can be interrupted.

The conveying path of the feed device 1 is aligned horizontally, which allows it to be set up close to the floor. However, it is also conceivable that the conveying path has a gradient of between 1° and 20°, preferably between 5° and 10°, relative to the horizontal.

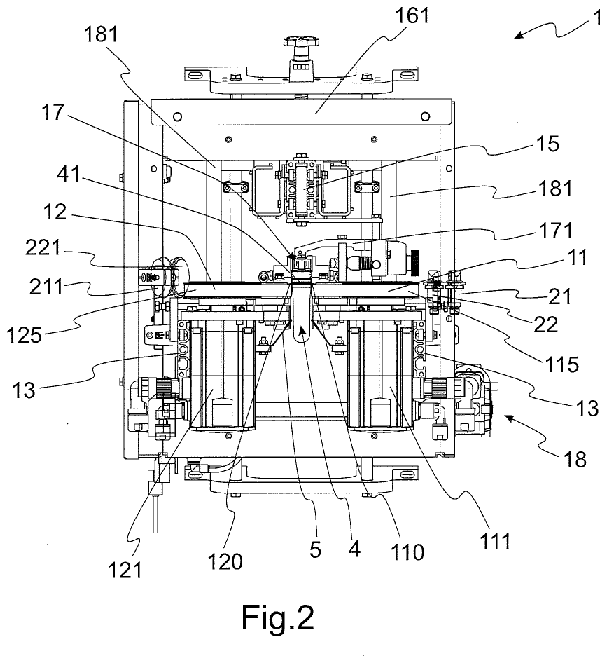

FIG. 2 shows a frontal view of the feed device 1 of FIG. 1. As can be seen in FIG. 2, the preform 4 rests via the support ring 41 on the lateral edge surfaces 110 and 120 of the conveyor belts 11 and 12, which are designed as toothed belts. The edge surfaces 110 and 120, which are formed by the upper lateral edges of the teeth of the toothed belts, therefore form a support for the supporting ring 41 of the preform 4. Due to the frictional force between the edge surfaces 110 and 120 of the conveyor belts 11 and 12 and the support ring 41, the support can be brought into engagement with the support ring 41 in such a way that an accumulation force is applied in the conveying direction to the preform located in the conveying path.

The distance between the conveyor belts 11 and 12 is adjusted by the width adjustment device 18 in such a way that there is sufficient space between the conveyor belts 11 and 12 for the preform 4. In addition, the surfaces 113 and 123 of the first and second conveyor belts 11 and 12, which are perpendicular to the lateral edge surfaces 110 and 120, form stabilizing surfaces for the preform 4, which limit a transverse deflection of the preform 4. By suitably adjusting the spacing between the conveyor belts 11 and 12, the surfaces 115 and 125 can also contact the elongated portion of the preform 4 below the support ring 41 (in this case, the tapered portion) and assist in conveying the preform 4.

In the embodiment shown, the conveyor belts 11 and 12 are made of polyurethane. The feed device 1 further has additional deflection limiting elements 5.

The conveyor belts 11 and 12 are driven by drives 111 and 121, as already shown in FIG. 1. As already described, it is also possible to drive the conveyor belts 11 and 12 by a common drive with a suitable reversing gear.

The height limit 17 is vertically adjustable via height adjustment elements 171 in the form of a lever arrangement. The other components of the feed device already described for FIG. 1 are designated with corresponding reference signs.

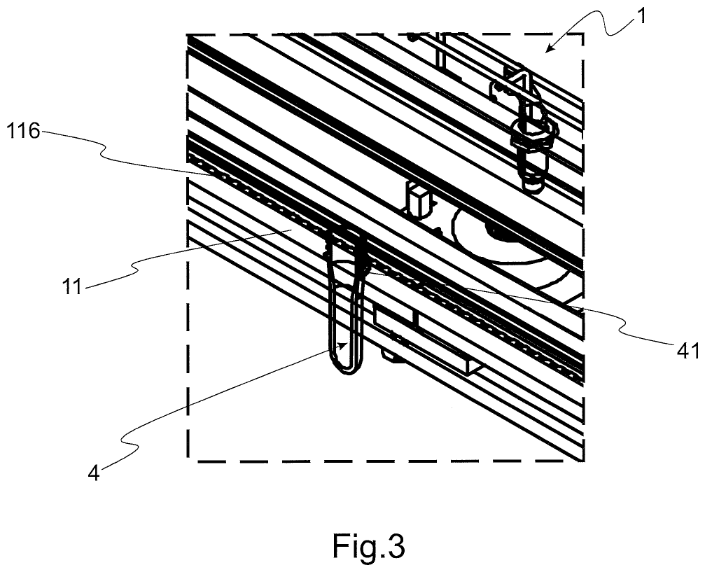

FIG. 3 shows a section of a perspective cut view of the feed device 1 from FIG. 1. In the cut view, the half preform 4 can be seen, whose support ring 41 rests on one side on the upper side edges of the teeth 116 of the conveyor belt 11, which is designed as a toothed belt.

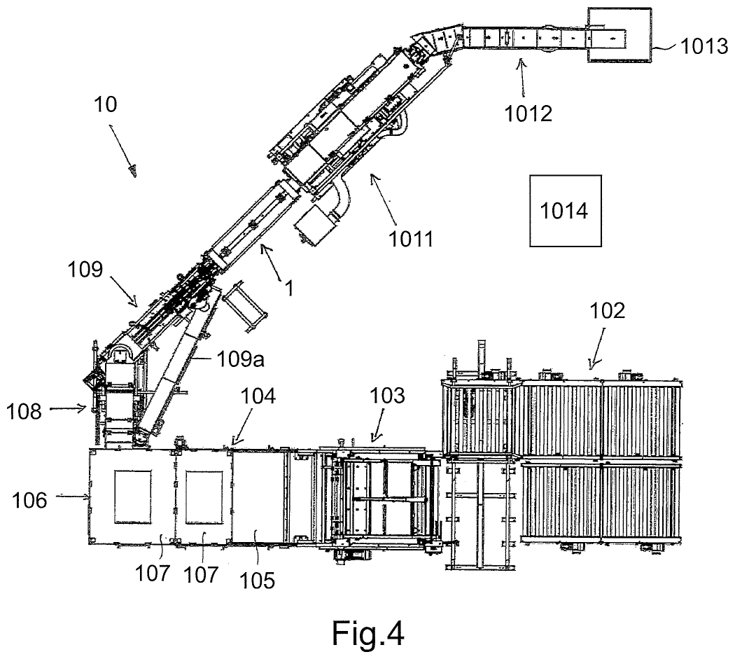

FIG. 4 shows a top view of an embodiment of a conveying system 10 for preforms comprising the feed device 1 of FIG. 1. Via the conveyor roller belt 102, cartons with preforms are brought to the tipping device 103, which picks up one carton at a time and discharges the contents, i.e. the preforms, onto a conveyor belt device 104. The conveyor belt device 104 comprises a first conveyor belt 105, a hopper-like device 106 and a second (transverse) conveyor belt arranged below the hopper-like device 106. The first conveyor belt 105 and the hopper-like device 106 each include a cover 107. The second conveyor belt transfers the preforms in an unordered manner to an elevator 108. A roller sorter 109 with a return belt 109a is connected to the elevator 108.

Downstream of the upstream module, which is designed as a roller sorter 109, the feed device 1 is provided, which takes over the correctly aligned, i.e. ordered, preforms from the roller sorter 109 and guides them to a downstream module designed as an infeed star of a clamp conveyor 1011.

A discharge rail 1012 is connected to the clamp conveyor 1011, via which the separated preforms pass into the stretch blow molder 1013. The feed device 1 can also guide the preforms directly to a stretch blow molder 1013 or to its infeed star. Furthermore, a control system 1014 is shown, which is connected to the minimum or maximum sensors and the gap sensors as well as the drives of the conveyor belts and, if necessary, the roller sorter 109 for accepting detection signals and for control.

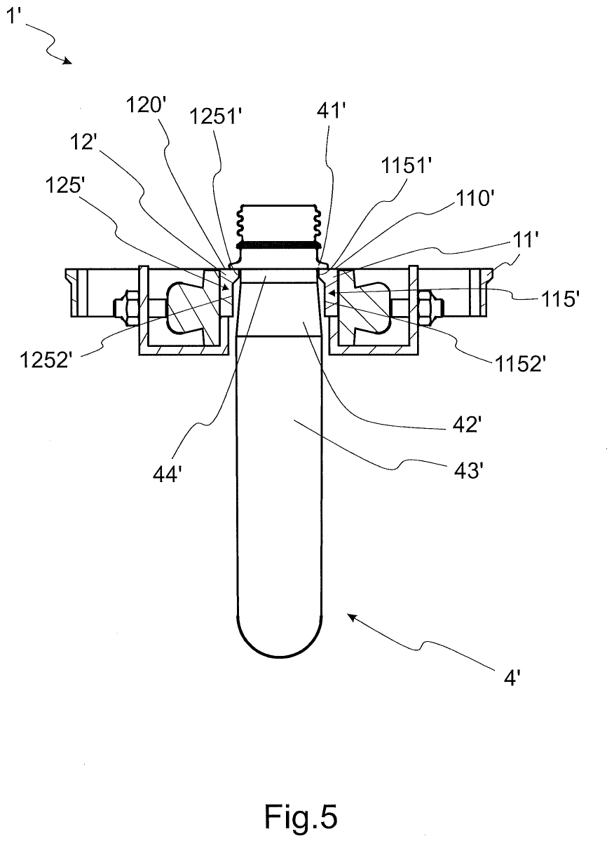

FIG. 5 shows a cut view of a section of an embodiment of a feed device 1′ with a first conveyor belt 11′ and a second conveyor belt 12′. The first and second conveyor belts 11′, 12′ each have a lateral edge surface 110′, 120′, which form a support for a support ring 41′ of a preform 4′. The first and second conveyor belts 11′, 12′ each have a stabilizing surface 115′, 125′, which serve opposite one another to stabilize a section 42′ of the preform 4′ adjoining below the support ring 41′. The stabilizing surfaces 115′, 125′ each have a gradation, so that the stabilizing surfaces 115′, 125′ each comprise a first partial stabilizing surface 1151′, 1251′ and a second partial stabilizing surface 1152′, 1252′, which is arranged below the first partial stabilizing surface 1151′, 1251′. The gradation is designed as an undercut, so that the distance between the conveyor belts 11′, 12′ in the conveyor section increases in a step-like manner in the direction facing away from the support, i.e. downwards in the FIG. 5 shown. The gradation comprises in each case a slope connecting the first partial stabilizing surface 1151′, 1251′ and the second partial stabilizing surface 1152′, 1252′. As can be seen in FIG. 5, the gradation of the stabilizing surfaces 115′, 125′ can be used to stabilize the section 42′, which is arranged below the support ring 41′ and has a conical shape. A straight cylindrical section 43′ adjoins the conically widening section 42′. It can be seen that the gradation of the stabilizing surfaces 115′, 125′ can also be advantageous, for example, for stabilizing a preform with an outwardly curved section adjoining below the support ring. Moreover, the first partial stabilization surfaces 1151′, 1251′ are spaced apart from each other in such a way that the first partial stabilization surfaces 1151′, 1251′ can engage with a vertical portion 44′ of the preform 4′ and assist in conveying the preform 4′.

1. A feed device (1, 1′) for a conveyor system (10) for preforms (4, 4′), which is designed to convey preforms (4, 4′) coming in an orderly manner from an upstream module (109) of the conveyor system (10) to a downstream module (1011) of the conveyor system (10), the feed device (1, 1′) comprising:
a first and a second conveyor belt (11, 11′; 12, 12′) each guided over at least two rollers (112, 113, 114; 122, 123, 124),
wherein a conveying path for the preforms (4, 4′) is formed between a first belt section of the first conveyor belt (11, 11′) and a second belt section of the second conveyor belt (12, 12′),
wherein the first and second conveyor belts (11, 11′; 12, 12′) are arranged such that a lateral edge surface (110, 110′) of the first conveyor belt (11, 11′) and a lateral edge surface (120, 120′) of the second conveyor belt (12, 12′) form a support for a support ring (41, 31′) of a preform (4, 4′), and
wherein the support can be brought into engagement with the underside of the support ring (41, 41′) in such a way that an accumulation force is applied in the conveying direction (F) to the preform (4, 4′) located in the conveying path.

2. The feed device (1, 1′) according to claim 1, wherein in each case a surface (115, 115′; 125, 125′) of the first and second conveyor belt (11, 11′; 12, 12′) oriented perpendicular to the edge surface (110, 110′; 120, 120′) forms two opposite stabilizing surfaces (115, 115′; 125, 125′) for the portion of the preform (4, 4′) adjoining below the supporting ring (41, 41′), which can be brought into engagement with the portion of the preform (4, 4′) adjoining below the supporting ring (41, 41′) in such a way that a deflection of the preform (4, 4′) located in the conveying path transversely to the conveying direction (F) is limited.

3. The feed device (1) according to claim 1, wherein the feed device (1) has a drive (111; 121) for each conveyor belt (11; 12).

4. The feed device according to claim 1, wherein the feed device comprises a common drive for the first and the second conveyor belt.

5. The feed device (1) according to claim 1, wherein the conveyor belts (11; 12) are made of a plastic.

6. The feed device (1) according to claim 1, wherein the conveyor belts are formed as toothed belts (11; 12), the support for a support ring (41) of a preform (4) being formed at least partially by side edges of the teeth (116) of the toothed belts (11; 12).

7. The feed device (1) according to claim 1, wherein the edge surfaces (110; 120) of the conveyor belts (11; 12), which are designed as a support for a supporting ring (41) of a preform (4), are designed in such a way that, when a limit accumulation force on a preform (4) located in the conveying path is exceeded, a sliding slip occurs between the edge surfaces (110; 120) and the supporting ring (41) of the preform.

8. The feed device (1) according to claim 2, wherein the stabilizing surfaces (115; 125) of the conveyor belts (11; 12) are aligned vertically.

9. The feed device according to claim 2, wherein the stabilizing surfaces of the conveyor belts have an inclination of between 5° and 10° with respect to the vertical.

10. The feed device (1′) according to claim 1, wherein the conveyor belts (11′, 12′) each have a stabilizing surface (115′, 125′) which are designed in such a way that the distance between the conveyor belts (11′, 12′) in the conveying path increases in the direction facing away from the support.

11. The feed device (1′) according to claim 10, wherein the stabilizing surfaces (115′, 125′) each have a gradation which divides the stabilizing surfaces (115′, 125′) each into a first partial stabilizing surface (1151′, 1251′) and a second partial stabilizing surface (1152′, 1252′), respectively.

12. The feed device (1) according to claim 1, wherein the conveyor belts (11; 12) are arranged in such a way that the conveying path is horizontal.

13. The feed device (1, 1′) according to claim 1, wherein the conveyor belts (11, 11′; 12, 12′) have a width such that the stabilizing surfaces (115, 115′; 125, 125′) cover at least one-twentieth of the height of the preform (4, 4′) located in the conveyor section.

14. The feed device (1, 1′) according to claim 1, wherein the conveyor belts (11, 11′; 12, 12′) have a width between 10 and 50 mm.

15. The feed device (1) according to claim 1, wherein a minimum sensor (21, 211) for detecting preforms is arranged at the downstream section of the conveying path of the feed device and a maximum sensor (25, 251) for detecting preforms is arranged at the upstream section of the conveying path of the feed device.

16. The feed device (1) according to claim 15, comprising at least one gap detection sensor is arranged between the minimum sensor (21, 211) and the maximum sensor (25, 251), which gap detection sensor is set up to detect gaps in the conveying path between preforms.

17. The feed device (1) according to claim 16, characterized in that the gap detection sensor is connected to a control system (1014) which, upon detection of one or more gaps, controls the at least one drive (111; 121) in such a way that the rotational speed of the conveyor belts (11; 12) is increased.

18. A conveying system (10) for preforms comprising a feed device (1) according to claim 1 and a plurality of preforms (4) which are conveyed at a variable distance from one another in the conveying path of the feed device (1), wherein an accumulation force can be applied to the preforms (4) in a downstream section of the conveying path of the feed device (1).

19. The conveying system (10) according to claim 18, wherein the feed device (1) is arranged downstream of an line-up sorter (109), and upstream of a take-off device (1011).

20. The conveying system (10) according to claim 18, wherein the conveying system (10) comprises a control system (1014) which is connected to gap detection sensors (22, 221; 23, 231; 24, 241) of the feed device (1) and, upon detection of one or more gaps, controls the at least one drive (111; 121) in such a way that the rotational speed of the conveyor belts (11; 12) is increased.
